(19) United States
(12) Patent Application Publication
(10) Pub. No.: US 2006/0065082 A1
(43) Pub. Date: Mar. 30, 2006

(54) Socket driving head for a box end wrench

(76) Inventor: Wen-Tsai Shyu, Taiping (TW)

Correspondence Address: KUO-HSIUNG CHIU, 13F., NO.23, JIUN-HO STREET, PEITUN DISTRICT, TAICHUNG, 406, TW

(21) Appl. No.: 10/950,300

(22) Filed: Sep. 27, 2004

(51) Int. Cl. B25B 23/16; B25G 1/00

(52) U.S. Cl. 81/177.85

(57) ABSTRACT

A socket driving head for a box end wrench having a main body, a quick-release bolt, a lock pin and an engaging steel ball. The main body consists of a polygonal member having a shape corresponding to that of a closed loop of the wrench. A semi-closed pin hole for movably receiving the lock pin by use of a first spring is provided at one side of a lower end of the polygonal member and communicated with a longitudinal hole of the main body. The main body further includes a polygonal neck with a ball hole. The quick-release bolt is received in the longitudinal hole of the main body by use of a second spring. Moreover, the quick-release bolt includes two arched recesses for receiving the lock pin and the engaging steel ball, respectively. Accordingly, an unexpected detachment of the socket driving head from the wrench is avoided.

### BACKGROUND OF THE INVENTION

1. Fields of the Invention

The invention relates to a socket driving head for a box end wrench, and more particularly, to an apparatus that acts a locking effect on a socket of the box end wrench to allow the operator to apply an downward force without accidental detachment.

2. Description of the Related Art

A box end wrench is a tool with a socket that fits over a nut or bolt head and is used to hold or twist a nut or bolt. Due to the fixed diameter of the socket, this tool can tighten or loosen nuts or bolts with a certain specification. So, it's often to see a set of box end wrenches of different diameters for sale in the market. However, this adds the financial and carrying burden to the operator and, therefore, leaves much to be desired.

In order to eliminate the aforementioned drawbacks, a kind of socket driving head for a box end wrench has been developed. By use of sockets of different sizes, this socket driving head for a box end wrench is applicable to many kinds of nuts or bolts to achieve convenience in use. However, the attachment force of the socket driving head to the closed loop of the box end wrench is limited. When the operator use the socket driving head to twist a nut or bolt, particularly for a strong twist, the socket driving head is easily detached from the closed loop of the box end wrench, thereby resulting in much inconvenience and trouble.

### SUMMARY OF THE INVENTION

It is a primary object of the invention to provide a socket driving head for a box end wrench that create an extra locking effect on the socket of the box end wrench so that an unexpected detachment of the socket driving head from the wrench is avoided.

### BRIEF DESCRIPTION OF THE DRAWINGS

The accomplishment of this and other objects of the invention will become apparent from the following description and its accompanying drawings of which:

FIG. 1 is an exploded view of a preferred embodiment of the invention;

FIG. 2 is a cutaway view of the assembled embodiment in accordance with FIG. 1;

FIG. 3 is a cutaway view of the assembled embodiment in accordance with FIG. 1 by compressing a quick-release bolt against a second spring; and

FIG. 4 is a cutaway view of another preferred embodiment of the invention.

### DETAILED DESCRIPTION OF THE PREFERRED EMBODIMENT

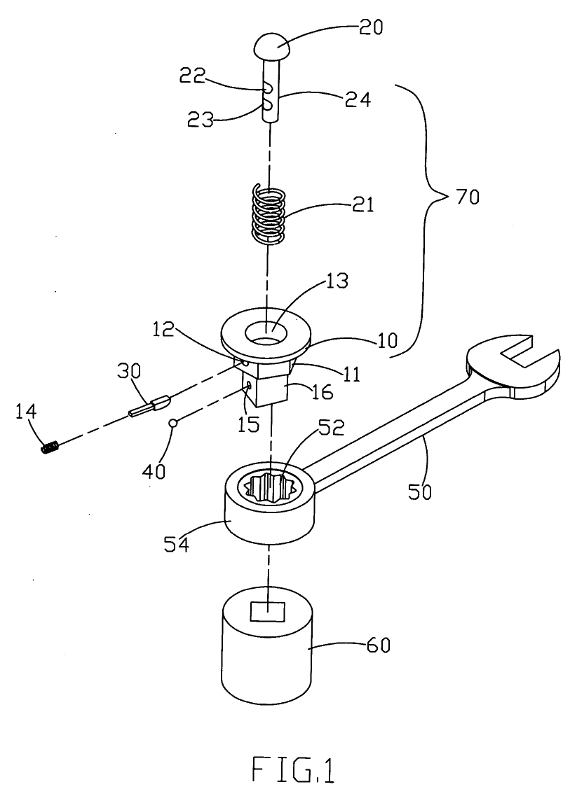

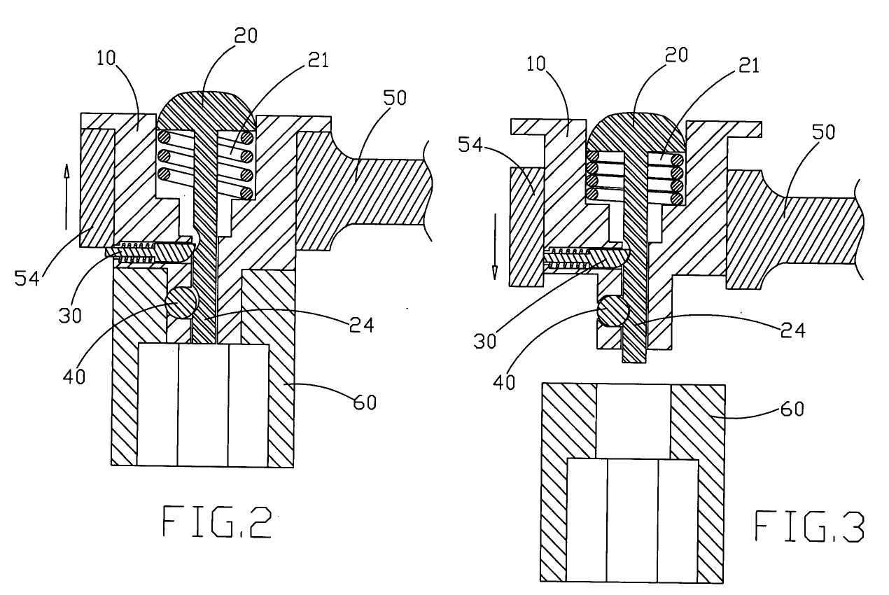

Referring to FIGS. 1 and 2, a socket driving head 70 of a first embodiment of the invention includes a main body 10, a quick-release bolt 20, a lock pin 30 and an engaging steel ball 40. The main body 10 consists of a polygonal member 11 having a shape corresponding to that of a closed loop 52 of the wrench 50. A semi-closed pin hole 12 for movably receiving the lock pin 30 by use of a first spring 14 is provided at one side of a lower end of the polygonal member 11 and communicated with a longitudinal hole 13 of the main body 10. The main body 10 further includes a polygonal neck 16 with a ball hole 15.

The quick-release bolt 20 is received in the longitudinal hole 13 of the main body 10 by use of a second spring 21. Moreover, the quick-release bolt 20 includes two arched recesses 22, 23 for receiving the lock pin 30 and the engaging steel ball 40, respectively.

Based on the assembly of the above-mentioned components, the head of the quick-release bolt 20 projects from the longitudinal hole 13 due to the resilience of the second spring 21. Meanwhile, a shaft of the quick-release bolt 20 forces the lock pin 30 and the engaging steel ball 40 to protrude outwardly. Thus, the projecting part of the lock pin 30 is located right under a wrench socket 54. In this way, the operator can press down the wrench 50 to twist a nut or bolt without worrying about an accidental detachment. In removing the socket driving head 70 from the socket 60 or the wrench socket 54, as shown in FIG. 3, the operator needs to press down the projecting quick-release bolt 20 in such a manner that the lock pin 30 and the engaging steel ball 40 fully fit into the arched recesses 22, 23, respectively. Accordingly, an easy and quick release of the socket driving head 70 from the wrench 50 and the socket 60 is achieved.

In order to reinforce the attachment of the socket driving head 70 to the wrench 50, a plurality of lock pins 30 is provided in the main body 10. For example, the main body 10 includes a semi-closed pin hole 12 at each side thereof for receiving the corresponding lock pins 30. A corresponding number of the arched recess 22 also has to be installed for reaching the expected effect.

Meanwhile, the resilience of the first spring 14 is applied to allow a thorough retraction of the lock pin 30 for an exact detachment from the closed loop 52 of the wrench 50.

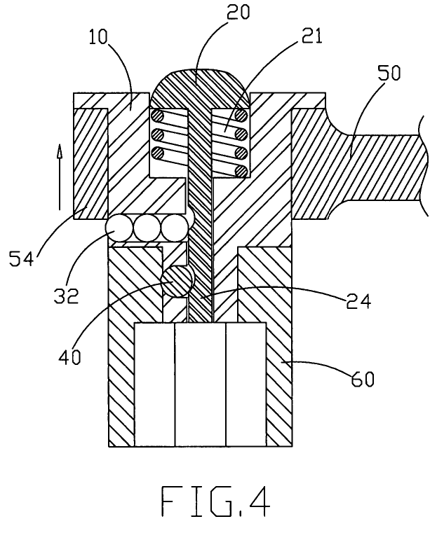

As shown in FIG. 4, the lock pin 30 can be replaced by several engagement balls 32 to obtain the same function of the lock pin 30. In this way, the first spring 14 is no more necessary for effectively reducing the number of the components and assembly hours.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A socket driving head for a box end wrench comprising:
a) a main body having a polygonal member with a shape corresponding to that of a closed loop of the box end wrench, a semi-closed pin hole for movably receiving a lock pin by use of a first spring being provided at one side of a lower end of the polygonal member and communicating with a longitudinal hole of the main body, the main body further having a polygonal neck with a ball hole; and
b) a quick-release bolt received in the longitudinal hole of the main body by use of a second spring, the quick-release bolt having two arched recesses for receiving the lock pin and an engaging steel ball, respectively,
whereby a shaft of the quick-release bolt forces the lock pin and the engaging steel ball to protrude outwardly, and, in removing the socket driving head from the socket or the wrench socket, the operator needs to press down the projecting quick-release bolt in such a manner that the lock pin and the engaging steel ball fully fit into the arched recesses to allow an easy and quick detachment of the socket driving head from the socket.

2. The socket driving head for a box end wrench as claimed in claim 1 wherein the main body includes a plurality of lock pins.

3. A socket driving head for a box end wrench comprising:
a) a main body having a polygonal member with a shape corresponding to that of a closed loop of the box end wrench, a semi-closed pin hole for movably receiving a plurality of engagement balls being provided at one side of a lower end of the polygonal member and communicating with a longitudinal hole of the main body, the main body further having a polygonal neck with a ball hole; and
b) a quick-release bolt received in the longitudinal hole of the main body by use of a spring, the quick-release bolt having two arched recesses for receiving the engagement balls and an engaging steel ball, respectively,
whereby a shaft of the quick-release bolt forces the engagement balls and the engaging steel ball to protrude outwardly, and, in removing the socket driving head from the socket or the wrench socket, the operator needs to press down the projecting quick-release bolt in such a manner that the engagement balls and the engaging steel ball fully fit into the arched recesses to allow an easy and quick detachment of the socket driving head from the socket.

4. The socket driving head for a box end wrench as claimed in claim 3 wherein the main body includes a plurality of sets of the engagement balls.
